(19) United States
(12) Patent Application Publication
(10) Pub. No.: US 2011/0153374 A1
(43) Pub. Date: Jun. 23, 2011

(54) REWARD TRAVEL MANAGEMENT SOFTWARE AND METHODS

(75) Inventors: Austin Veith, Boulder, CO (US); Krista Paul, Denver, CO (US)

(73) Assignee: USINGMILES, INC., Boulder, CO (US)

(21) Appl. No.: 12/873,020

(22) Filed: Aug. 31, 2010

Related U.S. Application Data
(60) Provisional application No. 61/275,622, filed on Aug. 31, 2009.

(51) Int. Cl. G06Q 30/00; G06Q 10/00; G06F 17/30

(52) U.S. Cl. 705/5; 707/769; 707/E17.014

(57) ABSTRACT

There is disclosed reward travel management software. In an embodiment, reward travel management software includes airline search results by airfare, the airline search results by reward points/miles fare, and a recommendation between the airfare and the reward points/miles fare by a recommendation engine. In another embodiment, reward points/miles management software includes auto rental search results by cash/credit card cost, the auto rental search results by reward points/miles cost, and a recommendation between the cash/credit card cost and the reward points/miles cost by a recommendation engine. In one embodiment, reward points/miles management software comprising product or service search results by cash/credit card cost, the product or service search results by reward points/miles cost, and a recommendation between the cash/credit card cost and the reward points/miles cost by a recommendation engine. Other embodiments are also disclosed.

### REFERENCE TO PENDING PRIOR PATENT APPLICATION

This application claims the benefit under 35 U.S.C. 119 (e) of U.S. Provisional Patent Application No. 61/275,622, filed Aug. 31, 2009 by Austin Veith, et al., for “REWARD TRAVEL MANAGEMENT SOFTWARE AND METHODS,” which patent application is hereby incorporated herein by reference.

### BACKGROUND

There are 180 million frequent flyers worldwide and 120 million in the United States alone. The online travel industry is the largest e-commerce category on the web with over $125 B in annual sales, and is projected to grow to $100 B in the next five years. The travel loyalty market is massive and growing, with 277,410,000 memberships in 2008. In fact, more than half of the adults who have traveled in the last 12 months belong to a loyalty program.

There are currently over 19 trillion unredeemed frequent flyer miles, which represent $400 billion U.S. dollars that are, for the most part, completely unmanaged by the holders. Frequent flyer miles are the single largest unmanaged asset class in existence. Despite the importance of this unique currency, frequent flyers find it extremely difficult to redeem miles. At the same time, airlines actually want consumers to stay involved in their loyalty programs and to find value in frequent flyer miles so that companies like Chase Bank will keep spending billions of dollars buying their miles. This is a huge opportunity to provide a service to this valuable segment of elite travelers (that account for 58% of all online travel bookings) and to make managing and redeeming frequent flyer miles as easy as booking a regular ticket online.

Several competitors have introduced different travel management components into some of their individual offerings. There is not a single site that provides tools to let users effectively manage, monitor, and book award travel all in one place. There is also no site that provides recommendations for future travel award opportunities or efficient use of miles. Some of these competitors include Mileage Manager, MileTracker, Acruw, Placely, and Points.com for mileage management. Yapta and Expert Flyer for award search functionality.

The following sites have implemented one or more travel management components.

1. The site Mileage Manager (www.mileagemanager) tracks a variety of award programs and is subscription-based. It is owned by Randy Petersen, a frequent flyer guru who sold FlyerTalk to Internet Brands in 2007. It is a subscription based service that charges users annually.

2. MilePort and MileTracker (www.mileport.com and www.miletracker.com) are downloadable desktop applications that track a variety of frequent flyer programs. There are no email notification systems and no ability to use the miles effectively.

3. Another site, Placely (www.placely.com), is limited to tracking 16 different award programs and only provides current balance information.

4. Points.com (www.points.com) is a website that allows users to track balances in a variety of programs. This site does not track other information such as expiring points, status, etc. This site allows users to proactively search for other ways to use their miles, with a primary focus on the consumer use of miles, such as trading them for Starbucks certificates, Blockbuster cards, and so on. This site provides a hotel booking feature to be used with points. This site does not provide any way to search for or book air travel using points and is more focused on the inactive traveler, not elite frequent flyers. Points.com is also developing a Global Points Exchange, which allows users to seek out other Points.com members who are interested in trading miles or points between reward programs. GPX brokers the exchange but the users are responsible for paying all of the fees associated with swapping points from airline to airline. The tool is still in its infancy and the fees make most trades cost prohibitive.

Expert Flyer (www.expertflyer.com) is a subscription-based site that allows users to search for award and upgrade availability from a variety of airlines. Users can also set up alerts for when award tickets become available for specific flights. There is no capability to manage miles or book flights. The user must be familiar with travel agency codes. There is a real need in the marketplace for a site that can help solve problems for frequent flyers.

Acruw (www.acruw.com) is a free site that allows users to track and manage the balances of their frequent flyer accounts. There is no capability to search for or book either regular or award based travel.

### SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an embodiment, there is provided travel management software providing airline search results by airfare, the airline search results by reward fare, and a recommendation between the airfare and the reward fare by a recommendation engine.

In another embodiment, there is provided reward points/miles management software comprising hotel search results by cash/credit card cost, the hotel search results by reward points/miles cost, and a recommendation between the cash/credit card cost and the reward points/miles by a recommendation engine.

In yet another embodiment, there is provided reward points/miles management software comprising auto rental search results by cash/credit card cost, the auto rental search results by reward points/miles cost, and a recommendation between the cash/credit card cost and the reward points/miles cost by a recommendation engine.

In still another embodiment, there is provided reward points/miles management software comprising product or service search results by cash/credit card cost, the product or service search results by reward points/miles cost, and a recommendation between the cash/credit card cost and the reward points/miles cost by a recommendation engine.

Additional objects, advantages and novel features of the technology will be set forth in part in the description which follows, and in part will become more apparent to those skilled in the art upon examination of the following, or may be learned from practice of the technology.

### BRIEF DESCRIPTION OF THE DRAWINGS

Non-limiting and non-exhaustive embodiments of the present invention, including the preferred embodiment, are described with reference to the following figures, in which:

FIG. 1 illustrates an embodiment of a graphical user interface for a Mile Manager tool;

FIG. 2 illustrates an embodiment of a graphical user interface for a Trip Monitor tool showing a list view;

FIG. 3 illustrates an embodiment of a graphical user interface for a Trip Monitor tool showing a map view;

FIGS. 4A-4C are schematic illustrations of exemplary embodiments of a recommendation engine; and

FIGS. 5-9 illustrate exemplary embodiments of graphical user interfaces for the novel travel management software.

### DETAILED DESCRIPTION

Embodiments are described more fully below in sufficient detail to enable those skilled in the art to practice the system and method. However, embodiments may be implemented in many different forms and should not be construed as being limited to the embodiments set forth herein. The following detailed description is, therefore, not to be taken in a limiting sense.

The novel travel management software allows frequent flyers to manage and utilize their miles and helps these frequent fliers recognize the value of this often overlooked asset. The novel travel management software is the helps users manage their loyalty portfolio, search for travel options, and book award travel or cash purchase flights.

The mileage management component of the novel travel management software eliminates the stress of managing multiple frequent flyer accounts from their individual sites. The novel travel management software makes it easy for users to aggregate all of their loyalty program information into one consolidated statement. In addition, users can set up notifications to receive alerts when miles or points are expiring, when enough miles/credits are available for free travel or rooms stays in their programs, or when elite status is achieved.

The novel travel management software facilitates the search for award fares and then tells users when enough miles or points are in their program to travel for free. Users can monitor a number of destinations and the novel travel management software serves up lowest published fares together with award travel options. The novel management software can also make recommendations for when it may be a better idea to use miles vs. cash or a combination of the two.

Lastly, the novel software facilitates online booking directly through deep linking with the supplier sites.

The novel travel management software helps frequent flyers successfully manage and utilize miles and points. Their novel software makes it easy for users to aggregate and track hundreds of reward programs from one place, i.e., a Single Graphical User Interface (GUI) at a website, and may include different types of rewards programs, including airline, hotel, rental car and credit card programs. Users can search for, and monitor, specific destinations for award fares/room stays and be notified when an award fare becomes available, and whether or not they have the miles/points to get it. The novel software may recommend when it is better to use cash vs. miles/points or when it is possible to use a combination of the two. The novel software may facilitate online booking for regular fares and award redemptions through deep linking directly into the supplier sites.

The novel travel management software comprehensively addresses the problems related to effectively managing multiple loyalty programs and redeeming miles/points for travel. Current competition merely tackles some individual components of the overall problem. These include MileageManager, MaxMiles, Acruw, Points.com for mile management. Others include Yapta, Expert Flyer for award search. Award booking is only available on individual supplier sites (e.g., United.com, SPG.com.)

Technology Platform

The novel travel management software applications and tools may be built using open source technologies based on the Linux, Apache, MySQL and PHP (LAMP) platform. These technologies allow effectively and affordably scaling in the long term. The novel travel management software may include five main components:

Account Management. This allows management of all loyalty program points and award travel planning from a single location.

Data Acquisition Engine. This automatically acquires loyalty program account information from suppliers via web sites and/or APIs.

Travel Search Engine. This allows on demand search of travel supplier inventory for award/published fares via supplier websites and/or APIs

Monitor and Notification Engine. This allows automatic notification of selected award trip availability, expiring points, etc.

Recommendation Engine. This evaluates the value of using points vs cash for selected travel and recommends a selection based on current travel and pricing trends.

In one embodiment, the basic travel management software is free to users. It has two primary and three secondary profit centers.

1. Commissions. Every time a user makes a purchase, a commission is received per transaction.

2. Advertising. Sites that target a similar demographic to the novel software are demanding. In addition, our team has experience running travel ad sales for Google and understands the sale process with leading advertisers.

3. Data. The novel travel management software collects and manages a tremendous amount of data that can provide analytical interest points to travel suppliers.

4. Premium Services. The novel software may be configured to offer premium services to power users for an additional fee.

5. White labeling. The novel software may be configured on other sites in exchange for a revenue share.

The novel travel management software allows frequent flyers to manage and utilize their miles and helps them recognize the value of this often overlooked asset. The novel software helps users manage their loyalty portfolio and search for and book award travel.

The mileage management component of the site eliminates the stress of managing multiple frequent flyer accounts from their individual sites. The novel software makes it easy for users to aggregate all of their loyalty program information into one consolidated statement. Users can track hundreds (143 to be exact) of reward programs from one place, including airline, hotel, rental car and credit card programs. In addition, users can set up notifications to receive alerts when miles or points are expiring, when they have enough miles/credits for free travel or rooms stays in their programs, or when they achieve elite status. Their reporting section allows them to organize a variety of reports, including an analysis of their purchasing power in each program (i.e., value of miles in cash and what they can redeem them for) and how they are trending to reach elite status for the year.

The novel travel management software facilitates the search for award fares and then tells users when they have enough miles or points in their program to travel for free. Users can monitor a number of destinations and the novel software technology serves up lowest published fares together with award travel options. The novel software can also make recommendations for when it may be a better idea to use miles vs. cash, or a combination of the two.

Lastly, TravelFli facilitates online booking directly through deep linking with the supplier sites. It is a seamless process so the user is transferred to the supplier site to complete the payment with a credit card or redeem miles.

Mile Manager

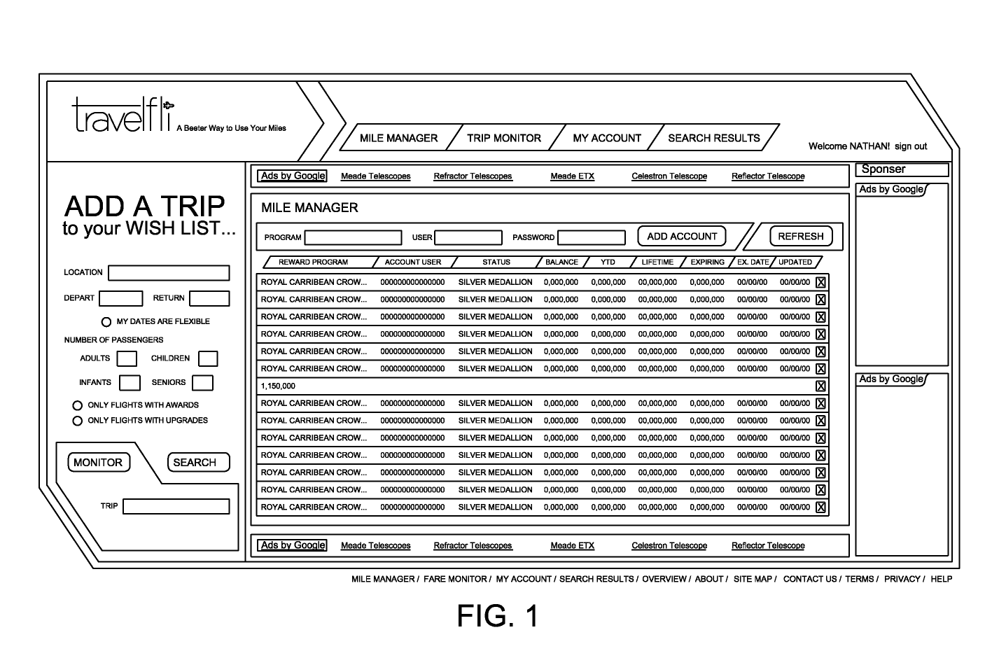

Referring to FIG. 1, there is shown an embodiment of a graphical user interface for a Mile Manager tool. The Mile Manager tool makes it easy to track hundreds of rewards programs from one single interface. It provides a single, unified statement of all the loyalty programs a frequent flyer is tracking in a form similar to an online bank statement, except it's measuring award currencies from hotels, airlines, credit card companies, and rental car agencies, to name a few. The users enter their account numbers one time and then the application automatically updates and tracks their accounts moving forward. A user never has to memorize or look up another frequent flyer number ever again!

The Mile Manager may track fares from many different airlines and reward programs, including hotels, rental cars, cruise lines, Diners clubs, credit cards, Internet services and more. In one embodiment, the Mile Manager tracks 143 airlines and reward programs. The tool is a very ‘sticky’ application, that keeps users coming back to the site frequently to check on mileage balances, recent activity, miles expirations and current bonus promotions.

The most powerful part of the Mile Manager is in its ability to notify users when specific events occur. For instance, it can notify users when their miles are within 30 days of expiring or when they are 25,000 miles away from elite status. It can alert a user in any number of ways, including e-mail, RSS feed, text message, or even LinkedIn and Facebook.

The notifications make it easy for people to keep track of their mileage balances without having to remember to stay on top of them. Everything is customizable to meet the specific needs of the individual, so frequent flyers have the power to tell TravelFli what they want to hear about, and when and how they want to hear it.

Trip Monitor

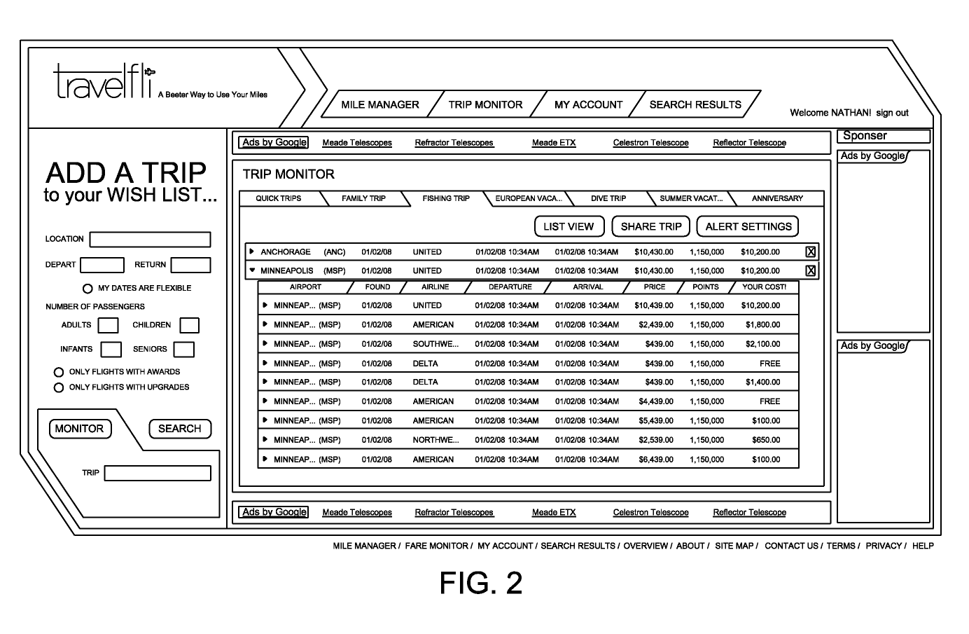

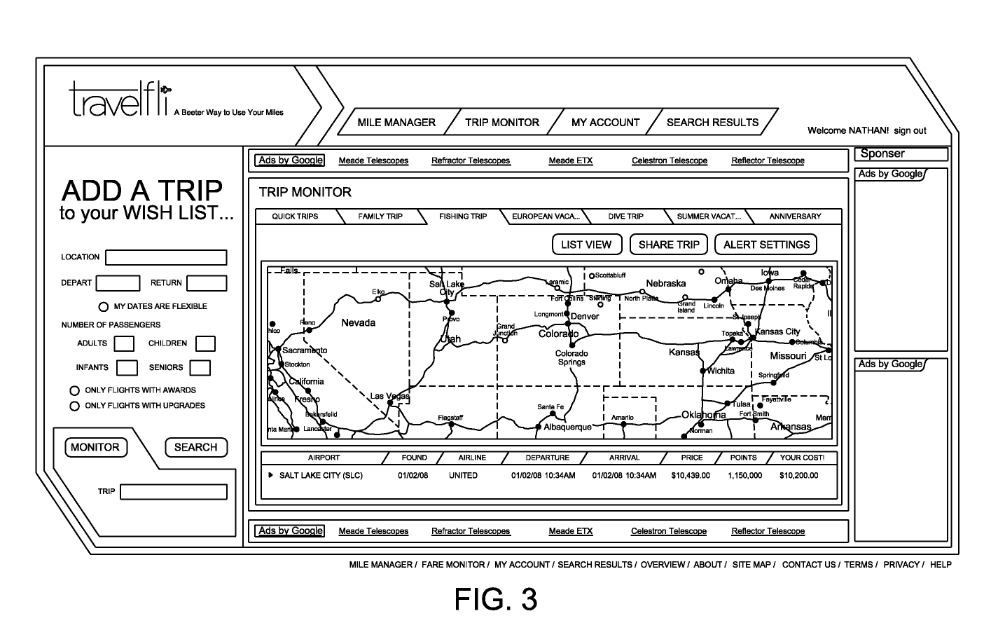

The Trip Monitor encourages users to create ‘wish lists’ of places they are planning on visiting, or would just like to see if the price is right. It will continuously monitor airfares between any two destinations and identify the lowest possible fare published anywhere on the Internet. However, the Trip Monitor goes a step further, and by pulling data from the airlines as well as a user's Mile Manager, can also notify users when they can go someplace (for free) using their miles. FIG. 2 illustrates an embodiment of a graphical user interface for a Trip Monitor tool showing a list view. FIG. 3 illustrates an embodiment of a graphical user interface for a Trip Monitor tool showing a map view.

In addition to recommending flights, the Trip Monitor makes intelligent recommendations for users to book complete trips. For example, the Trip Monitor will not only notify a user when an award seat to their destination is available, but will suggest additional use of miles, such as booking a hotel and car through Marriot Rewards or Hertz points. It also indicates whether or not the trip is a cost-effective way to use those miles or if it is better to just use cash.

Users can track destinations individually, or create “theme trips.” In other words, if they just want to go to Jamaica, they can do that. But if they want to take a scuba diving trip and track numerous destinations like St. Thomas or Grand Cayman, they can do that too. Our Trip Monitor allows them to create a tab, named “dive trip” for example, which aggregates all the information from different destinations (including monitored fares, hotels, rental cars, etc.) into one place.

When a person starts monitoring a destination, the Trip Monitor automatically pinpoints the nearest airports to that place from a database of nearly 10,000 airports worldwide. The user can set up notification preferences to receive an e-mail, SMS, IM, etc., when a low fare is detected or when certain pricing parameters are reached. The application can also be used to find the best rates or award availability for hotels or rental cars.

The novel travel management software may use a custom-built data mining set to retrieve award information. The novel software may be integrated with Global Distribution Systems (GDSs) like Sabre or ITA. The novel software may be used in partnership with Sabre or other data providers. This will provide a reliable stream of real-time information on award seating and upgrade availability. The novel software may also be used with direct relationships with the airlines in order to receive direct XML feeds into their systems.

The Trip Monitor is an incredibly powerful tool that provides an easy solution for frequent travelers seeking a better way to plan and book award travel. The novel software development team has simplifies the process of researching award seating and upgrades with an easy-to-use tool that doesn't require a thorough understanding of fare buckets and other airline jargon. Users may drill down through detailed information or alter the way it is displayed (map vs. list) to suit their personal needs and/or knowledge of the award process. Other features include but are not limited to:
Ability to search for multi-segment trips
Search a 30 day period for a pair of cities for lowest prices and/or award seating and upgrade availability
Ability to search for multiple fare classes and to exclude and/or include specific airlines

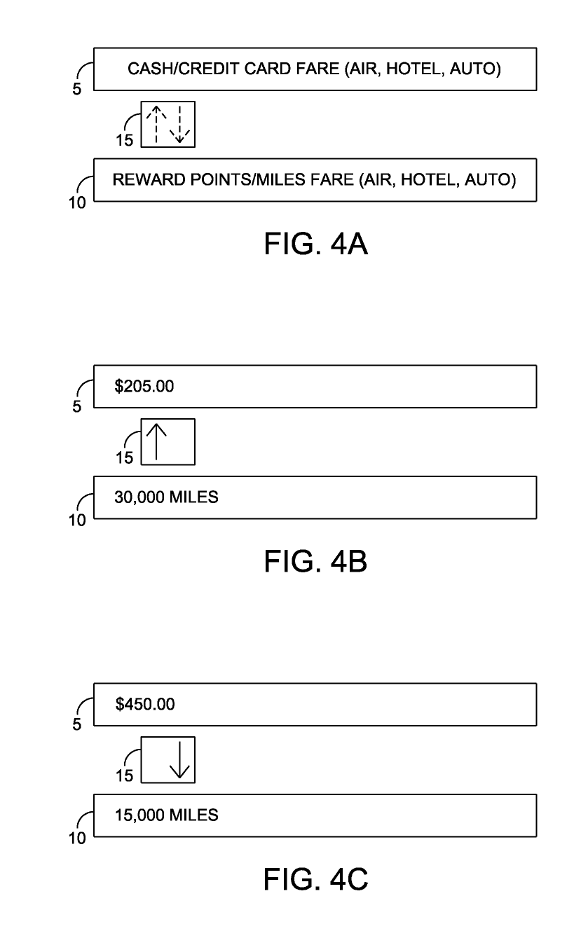

Booking Tool The novel travel management software may include, a “first of its kind” award booking tool that allows users to book award travel on a variety of airlines, hotels, and rental car agencies from one place directly within the site. Travelers can immediately book award fares and save themselves the painstaking hassle of calling the airlines repeatedly, months in advance, just to book an awards seat. In an embodiment, the Booking Tool may include a recommendation engine (see FIGS. 4A-4C.) Code may be provided for making a comparison between airline search results by airfare 5, the airline search results by reward fare 10, and a recommendation between the airfare and the reward fare by a recommendation engine 15. In an embodiment, a single graphical user interface may display recommendation engine 15 together with airfare 5 and reward fare 10 for a selected airline itinerary, hotel stay, or automobile rental. The recommendation may include, but is not limited to, an arrow configured to point to the best value (the arrows are shown in phantom in FIG. 4A.) An arrow may point to the cash/credit card fare for a lower “cost” than the reward fare (FIG. 4B) or an arrow may point to the reward fare for a lower “cost” than the cash/credit card fare (FIG. 4C.)

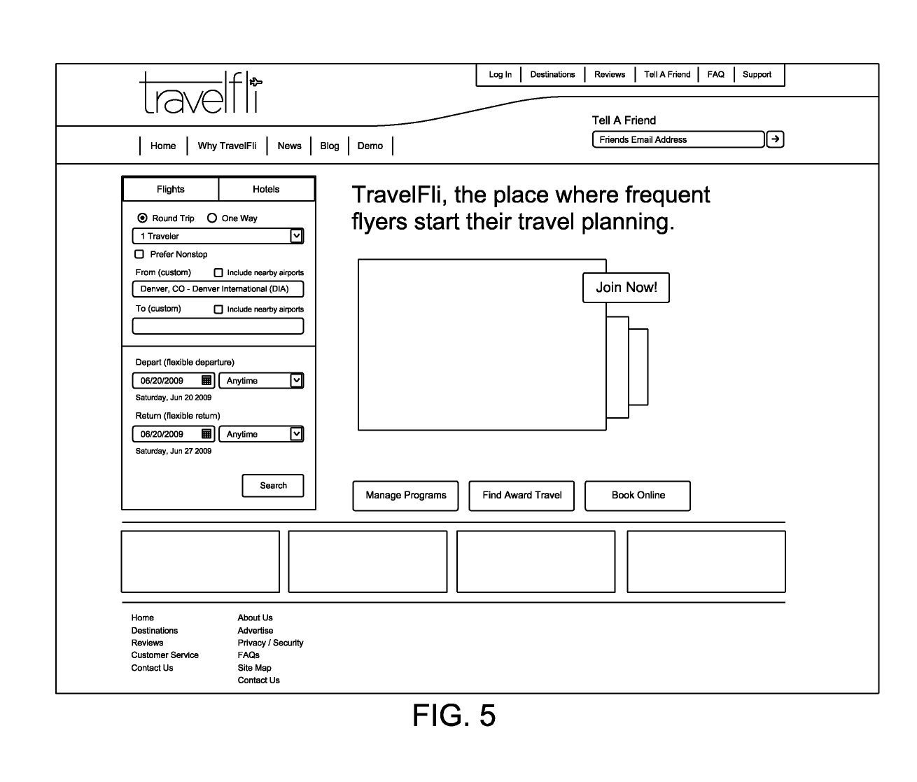

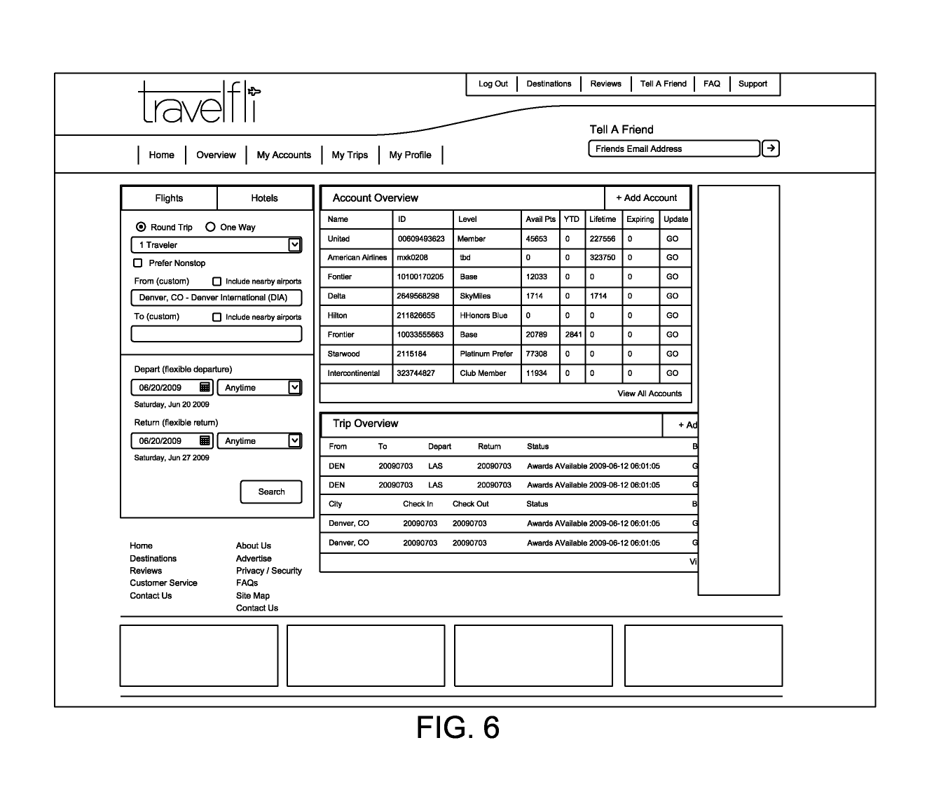

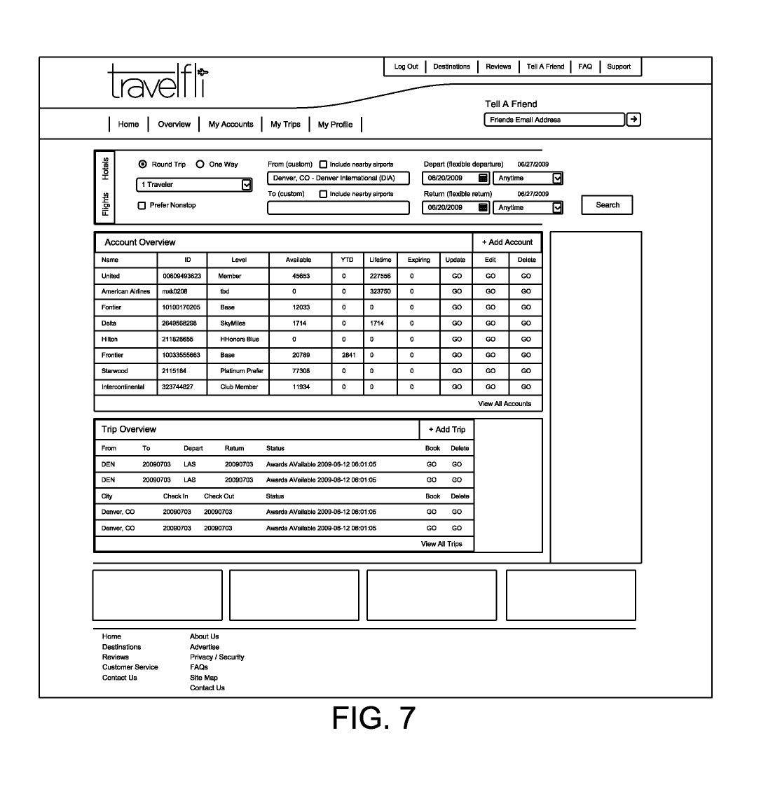

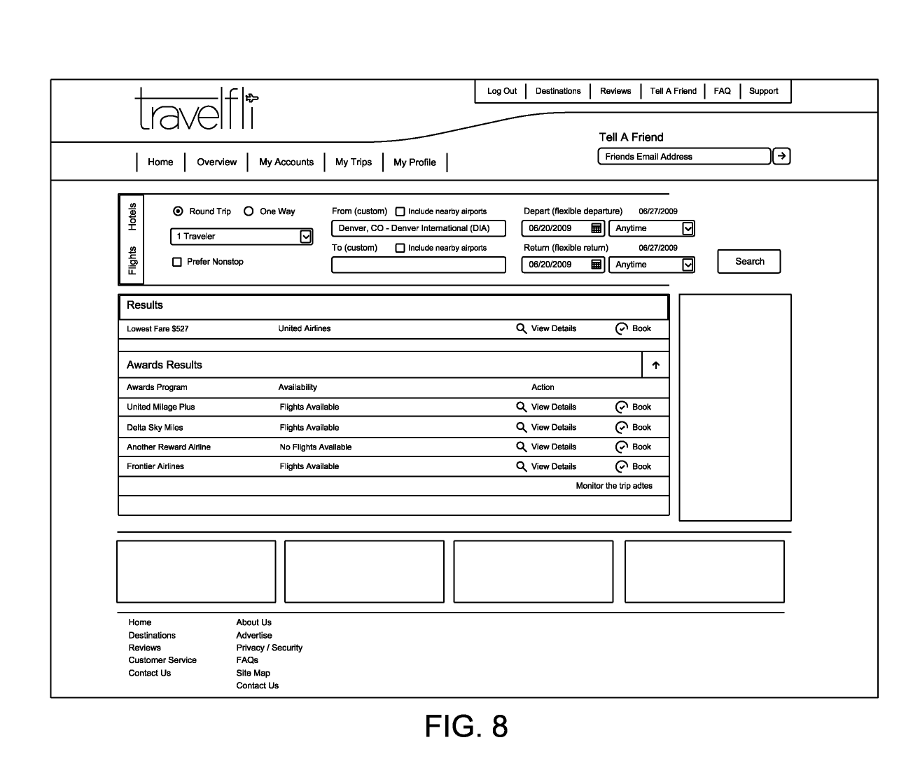

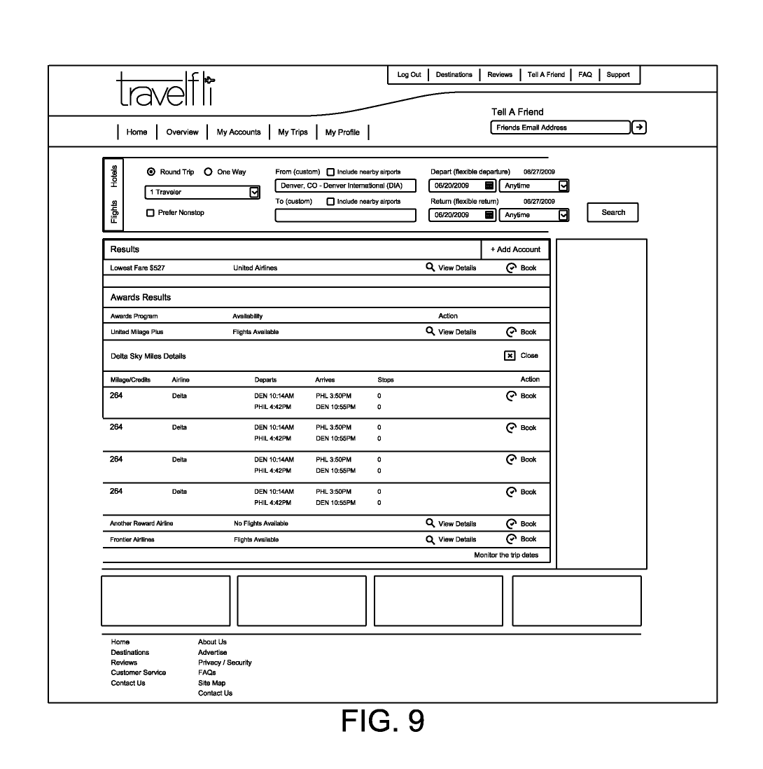

Referring now to FIGS. 5-9, there are shown exemplary embodiments of graphical user interfaces for the novel travel management software. FIG. 5 illustrates an initial graphical user interface in which the user has not logged in. In FIGS. 6 and 7, there are shown graphical user interfaces in which a user is logged in to the novel management software via an Internet website. In FIGS. 8 and 9, there are shown graphical user interfaces in which results are displayed to a user. Additional travel details are shown in FIG. 9.

Demographics
The worlds' frequent flyer programs boast more than 180 million members, 120 million of whom are U.S. residents.
17 million Americans are considered “elite flyers”—having taken nine or more round-trip flights in the past year. Even though this segment makes up just 14% of airline travelers, frequent flyers account for 58% of all online travel purchases. Frequent flyers are over three times as likely to live in $100,000+ households. 87% of frequent flyers are heavy users of broadband internet access. 58% of frequent flyers are male. Over the past 10 years, loyalty programs have grown at an average rate of 11% annually. Excluding bonuses (class of travel bonuses and bonus promotions), about 54% of miles earned are not from flying. Statistics compiled by Randy Petersen, Publisher/Editor Inside Flyer magazine. Arbitron Airport Study, 2004

Why the Airlines Care

The common perception is that airlines do not want people to redeem their frequent flyer miles. Interestingly enough, this couldn't be further from the truth. AIRLINES DEPEND ON PEOPLE USING THEIR FREQUENT FLYER MILES!

Frequent flyer miles (loyalty programs) are big business for the airlines. Frequent flyer programs are often the most profitable division of almost every airline's operations. The reason for this is due largely to the popularity of “co-branded” credit cards and other similar programs that reward consumers with frequent flyer miles for a variety of everyday consumer activities.

For example, institutions such as Chase Bank buy blocks of miles from the airlines to be distributed to their credit card users. Chase pays for these miles in cash, up front. The airlines literally look at these programs as they would an ATM, or as a means to raise fast cash without having to utilize more traditional and binding means (such as bond issuance or selling stock.) It is a vital component of the airline's business model.

Last year United Airlines sold over 1.2 Billion dollars worth of miles to Chase Bank in just one transaction! Overall, revenues from the loyalty division accounted for nearly 6 Billion dollars of income for United in 2007.

Airlines spend millions every year in customer retention campaigns. The reason for this is that airlines like United want consumers to stay involved in their loyalty programs and to find value in frequent flyer miles so that companies like Chase Bank will keep spending billions of dollars buying their miles. The novel software acts as a free user retention program for the airlines while providing new income streams from traditional fare purchases, ancillary purchases, and co-branding opportunities. Most importantly, the novel software helps customers maximize the value they get out of their programs. This deepens the customers attachment to their programs and increases their value to the travel supplier.

The novel software is also a great value to the airlines on a distribution side. All airlines, without exception, are looking for lower cost, higher yielding distribution channels. Because of the novel software's metasearch model, they are able to drive revenue to airlines at a far lower cost than Travelocity, Expedia, or any other online travel agency. In addition, due to the novel software's high end demographic, the revenue driven to airlines and hotels will be higher yielding than other distribution partners.

Due to the airlines and hotels partnerships with credit cards, loyalty programs are often the most profitable part of a travel suppliers business. Travel suppliers depend on consumers perceived value of loyalty programs. The novel system helps customers maximize the value they get out of their programs. This deepens the customers attachment to their programs and increases their value to the travel supplier.

There is a tremendous amount of data attached to a frequent flyer number. The airlines and credit card companies have done a great job over the past 20+ years making sure that there is almost as much demographic and personal data linked to a frequent flier number as there is to an individual's Driver's License Number or even their Social Security Number. In cooperation with the consumer, the novel software can unlock that information and transparently put it to work for the user in a way similar to how the airlines and credit card companies use it. The novel software can anonymously cross compare users' travel histories and make extremely relevant purchase suggestions based on similar consumer behaviors and supplier promotions/product availability.

By combining the information and travel history attached to a frequent flyer number with the applications and entered data on the novel software, companies may better serve their best customers (or those of their competitors) and leverage that information to help consumers find the products they want at the lowest possible price.

Here are just a few examples of how that information and novel software tools work together to provide solutions for both the consumer and the supplier:
The demographic and personal data associated with a frequent flier number can be used to pre-fill data fields and reduces the barrier to use for the consumer.
With the user's permission, the Trip Monitor will analyze a user's travel history and automatically monitor destinations of interest or make highly personalized recommendations with almost no effort on behalf of the user.
The Trip Monitor can also provide consumer demand data for companies like airlines and hotels that help them better evaluate their scheduling, loads, and rate structures through a more accurate and accessible process that has never been available before.
Automated survey tools that issue “on the fly” surveys to the user base of the novel software in order to provide specific information for contracted researchers and may reward users with what frequent flyer miles.
Contextual searching to provide random, unsolicited market data for multiple industries.
Flight demographics to provide exact consumer data and service responses.

Although the above embodiments have been described in language that is specific to certain structures, elements, compositions, and methodological steps, it is to be understood that the technology defined in the appended claims is not necessarily limited to the specific structures, elements, compositions and/or steps described. Rather, the specific aspects and steps are described as forms of implementing the claimed technology. Since many embodiments of the technology can be practiced without departing from the spirit and scope of the invention, the invention resides in the claims hereinafter appended.

What is claimed is:

1. Reward travel management software comprising airline search results by airfare, the airline search results by reward points/miles fare, and a recommendation between the airfare and the reward points/miles fare by a recommendation engine.

2. Reward travel management software in accordance with claim 1 further comprising award management software for reward points/miles.

3. Reward travel management software in accordance with claim 1 further comprising search monitoring for air travel.

4. Reward travel management software in accordance with claim 1 further comprising booking software for reward points/miles.

5. Reward travel management software in accordance with claim 4 wherein booking software is configured to deep link into an airline website for purchasing the reward points/miles fare.

6. Reward travel management software in accordance with claim 5 wherein booking software is configured for purchasing the reward points/miles fare with a single click at the airline website after selecting an option to purchase the reward points/miles fare.

7. Reward points/miles management software comprising hotel search results by cash/credit card cost, the hotel search results by reward points/miles cost, and a recommendation between the cash/credit card cost and the reward points/miles by a recommendation engine.

8. Reward travel management software in accordance with claim 7 further comprising award management software for reward points/miles.

9. Reward travel management software in accordance with claim 7 further comprising search monitoring for hotels.

10. Reward travel management software in accordance with claim 7 further comprising booking software for reward points/miles.

11. Reward travel management software in accordance with claim 10 wherein booking software is configured to deep link into an hotel website for purchasing the reward points/miles fare.

12. Reward travel management software in accordance with claim 11 wherein booking software is configured for purchasing the reward points/miles cost with a single click at the hotel website after selecting an option to purchase the reward points/miles cost.

13. Reward points/miles management software comprising auto rental search results by cash/credit card cost, the auto rental search results by reward points/miles cost, and a recommendation between the cash/credit card cost and the reward points/miles cost by a recommendation engine.

14. Reward travel management software in accordance with claim 13 further comprising award management software for reward points/miles.

15. Reward travel management software in accordance with claim 13 further comprising search monitoring for auto rental.

16. Reward travel management software in accordance with claim 13 further comprising booking software for reward points/miles.

17. Reward travel management software in accordance with claim 16 wherein booking software is configured to deep link into an auto rental website for purchasing at the reward points/miles cost.

18. Reward travel management software in accordance with claim 17 wherein booking software is configured for purchasing the reward points/miles fare with a single click at the airline website after selecting an option to purchase the reward points/miles fare.

19. Reward points/miles management software comprising product or service search results by cash/credit card cost, the product or service search results by reward points/miles cost, and a recommendation between the cash/credit card cost and the reward points/miles cost by a recommendation engine.
